(19) United States
(12) Patent Application Publication
(10) Pub. No.: US 2010/0154084 A1
(43) Pub. Date: Jun. 17, 2010

(54) METHOD AND APPARATUS FOR PERFORMING APERTURELESS NEAR-FIELD SCANNING OPTICAL MICROSCOPY

(75) Inventors: Alexei Sokolov, Copley, OH (US); Alexander Kisliuk, Akron, OH (US); Ryan Hartschuh, Copley, OH (US)

Correspondence Address: Joseph J. Crimaldi;Roetzel & Andress, 222 S. Main St., Akron, OH, 44308, US

(73) Assignee: THE UNIVERSITY OF AKRON, Akron, OH (US)

(21) Appl. No.: 12/529,722

(22) PCT Filed: Oct. 30, 2008
(86) PCT No.: PCT/US2008/061270

§ 371 Date: Feb. 11, 2010

Related U.S. Application Data
(60) Provisional application No. 60/925,912, filed on Apr. 24, 2007.

(51) Int. Cl. G01Q 10/00; G01Q 60/22; G02B 21/04; G01Q 30/20

(52) U.S. Cl. 850/1; 850/32; 359/384; 850/18

(57) ABSTRACT

A microscope for performing apertureless near-field scanning optical microscopy on a sample comprising a means for mounting a sample; a scanning probe; means for illuminating the sample with light along optical axes from at least two illumination angles relative to an imaginary line connecting the probe and the sample; means for enhancing the electric field of light in a region of the sample with the probe; means for scanning the sample in a plane perpendicular to an imaginary line connecting the probe and the sample; means for moving said sample along said imaginary line to maintain a nearly constant distance between the probe and the sample; and means for collecting light scattered, emitted, or transmitted from the sample.

### BACKGROUND OF THE INVENTION

The present invention is directed to an apparatus and method for optical imaging of transparent and non-transparent materials with nanoscale spatial resolution. This invention relates generally to optical microscopy and scanning probe microscopy and more specifically to apertureless near-field scanning optical microscopy.

Many technological fields are embracing the advances of nanotechnology, e.g. biological sciences, biomedical engineering, and the electronics and photonics industries. One challenge for nanotechnology is characterization of materials with nanoscale dimensions. Traditional characterization methods used for micro- and macroscopic materials are not efficient at the nanometer scale regime. One such field, optical imaging and particularly spectroscopy, provides a wealth of materials information based on chemical specificity, molecular conformations and dynamics, and optical properties. Traditional imaging techniques based on visible light are physically limited in spatial resolution to several hundreds of nanometers (wavelength of light).

Existing technologies have significantly improved the capability of optical methods for nanoscale imaging. Techniques using apertures smaller than the wavelength of light, when placed very near to a sample to be analyzed (distance less than 100-10 nm), can obtain optical images with resolution near 100 nm (A. Lewis Nat. Biotech. 2003). However, aperture-limited microscopy is restricted by strong reduction of signal intensity with decreasing aperture diameter, (improving resolution). For applications in which light intensity is inherently low, such as Raman scattering, physical drawbacks of aperture-limited techniques reduce its practicality. Aperture-limited microscopy is typically referred to as Near-field Scanning Optical Microscopy (NSOM).

Apertureless-NSOM (a-NSOM) has provided greatly improved resolution and in some cases yielded images with spatial resolution below 20 nm (Ma 2006, Anderson 2006). In a-NSOM, a nanoantenna is placed in the focus of a light beam, where it focuses energy of light close to its apex (called the near-field light) and locally enhances the intensity of incident and scattered light. Many variations of a-NSOM have been proposed and developed, with advantages and disadvantages to each of them.

Examples of existing technologies include U.S. Pat. No. 7,047,796, assigned to Nanonics and entitled “Multiple plate tip or sample scanning reconfigurable scanned probe microscope with transparent interfacing of far-field optical microscopes”. This patent teaches a microscope using one optical axis, in which two objectives have a common centered axis. U.S. Pat. No. 6,985,223 to Drachev, entitled “Raman imaging and sensing apparatus employing nanoantennas”, teaches an apparatus with a metal tip and metal surface or substrate, and includes a spectrometer. U.S. Pat. No. 6,850,323 to Anderson, entitled “Locally enhanced Raman spectroscopy with an atomic force microscope” teaches an apparatus and a method which includes a Raman spectrometer and a side illumination direction approximately perpendicular to an imaginary line connecting the tip and the sample. U.S. Pat. No. 6,643,012 to Sun & Shen, entitled “Apertureless near-field scanning Raman microscopy using reflection scattering geometry”, teaches a Raman spectrographic system, a near-field scanning Raman spectrometer, and a method of performing apertureless near-field scanning Raman microscopy with one or two reflection geometry lenses. U.S. Pat. No. 6,002,471 to Quake, entitled “High resolution scanning Raman microscope” teaches the use of a reference beam to detect “a change in surface profile by differencing a reference beam from a reflected signal of the reference beam”.

### SUMMARY OF THE INVENTION

The present invention overcomes the significant disadvantages of the known a-NSOM techniques by providing a versatile, optimally configured a-NSOM microscope that combines the ability to collect the highest intensity of scattered light without the restrictions to the choice of sample and/or substrate associated with existing techniques.

The apparatus and method of the present invention can perform optical imaging of materials with nanoscale lateral resolution. The present invention operates on two optical axes, but with one lens in a reflection geometry and one lens in an inverted geometry and may be used with any type of optical analysis and detection instrument. The side angle of the present invention is not considered perpendicular, but at an angle between parallel and perpendicular to an imaginary line connecting the tip and the sample. The present invention utilizes a feedback mechanism for surface profiling, namely the frequency, phase, and/or amplitude of a crystal oscillator.

### BRIEF DESCRIPTION OF THE DRAWINGS

The foregoing, and additional objects, features and advantages of the present invention will be understood from the following detailed description of preferred embodiment thereof, taken with the accompanying drawings, in which:

FIG. 1 is a diagrammatic illustration of an a-NSOM setup with a tuning fork and probe vibrating approximately perpendicular to the surface plane of the sample;

FIG. 2 is a diagrammatic illustration of an alternative probe geometry for an a-NSOM setup with a tuning fork and tip vibrating approximately parallel to the surface plane of the sample;

FIG. 3 is a series of diagrammatic illustration of tip/probe geometries for alternative SPM and a-NSOM modes;

FIG. 4 is a diagrammatic illustration of a mirror system A with a removable or semi-transparent mirror;

FIG. 5 is a diagrammatic illustration of a mirror system B with a removable side objective and vertically sliding inverted objective and mirror; and

FIG. 6 is a diagrammatic illustration of a mirror system C with an adjustable incident angle (θ) for the side objective.

### DETAILED DESCRIPTION OF THE INVENTION

The present invention is directed to a scanning probe microscope, confocal microscope, and apertureless near-field scanning optical microscope, which can be fully integrated with a spectrometer, a far-field optical microscope, which is upright, inverted, and/or at an off-normal angle from above or below, and uses a variety of tip scanning schemes.

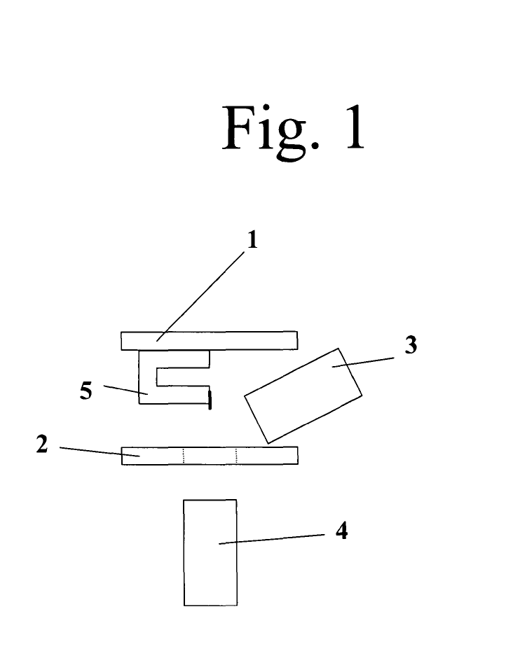

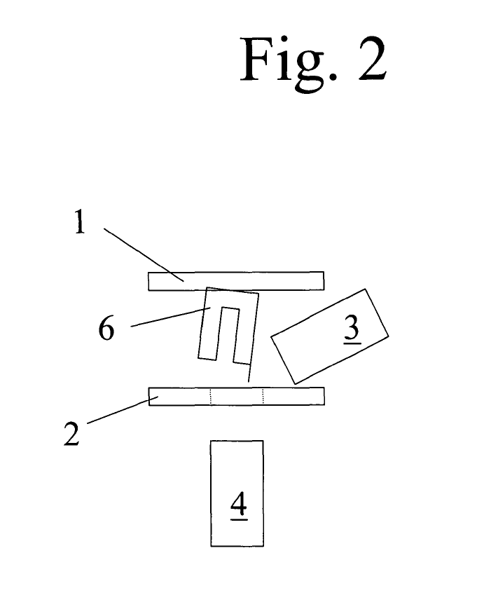

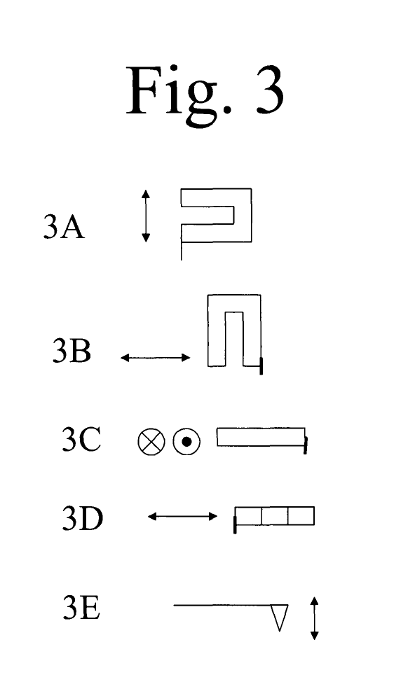

The scanning probe microscope is shown generally in FIG. 1, in which a top stage 1, having an XYZ motion control or fixed position, is positioned above a bottom XYZ stage 2. A side-angle aperture, lens, or microscope 3 is directed at bottom stage 2, while an inverted aperture, lens, or microscope 4 is directed at bottom stage 2 from underneath bottom stage 2. A probe 5 attached to the end of a tuning fork so that it will oscillate approximately perpendicular to the sample. FIG. 2 is a variation of FIG. 1 in which the probe 6 is attached to the side of a tuning fork oscillating approximately perpendicular to the sample. FIG. 3 illustrates other variations in the set up of the tuning fork and the probe. For example, FIG. 3C illustrates a probe attached to the end of a tuning fork oscillating approximately parallel to the sample. FIG. 3D illustrates a probe attached to the edge of a tuning fork oscillating approximately parallel to the sample, and FIG. 3E illustrates a cantilevered probe oscillating approximately perpendicular to the surface.

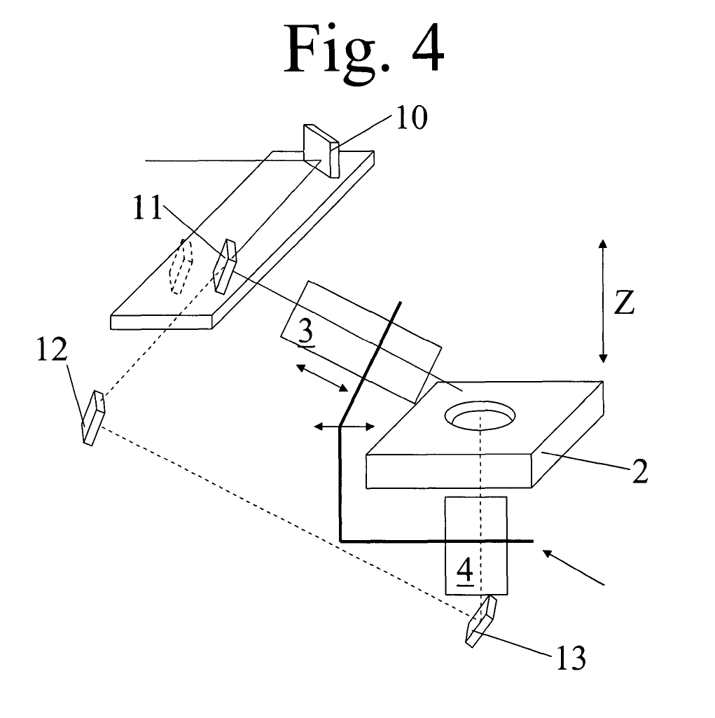

As seen in FIG. 4, a mirror system 10 with a removable or semi-transparent mirror 11 allows inverted or side-angle/inverted microscopy. The dashed line illustrates the use of the inverted microscope in the absence of the removable mirror. The solid line illustrates the use of the side-angle microscope, which can be used simultaneously with the inverted microscope if mirror 11 is semi-transparent. Objects 3 and 4, which are apertures, lenses, or microscopes, are fixed with respect to each other in one plane, but move independently within that plane. Also employed are adjustment mirror 12 and vertically sliding mirror 13.

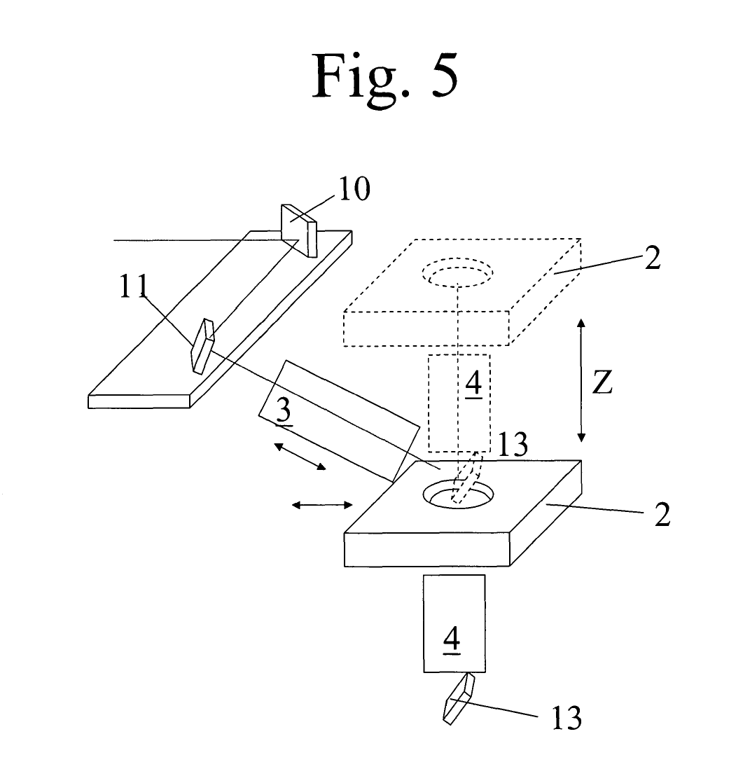

FIG. 5 illustrates a mirror system with a removable side objective 3 and vertically sliding inverted objective 4 and mirror 13. The side-angle microscopy is converted to inverted microscopy by removing object 3 and vertically translating objects 2, 4, and 13. Objects 3 and 4 move independently on XYZ translational stages.

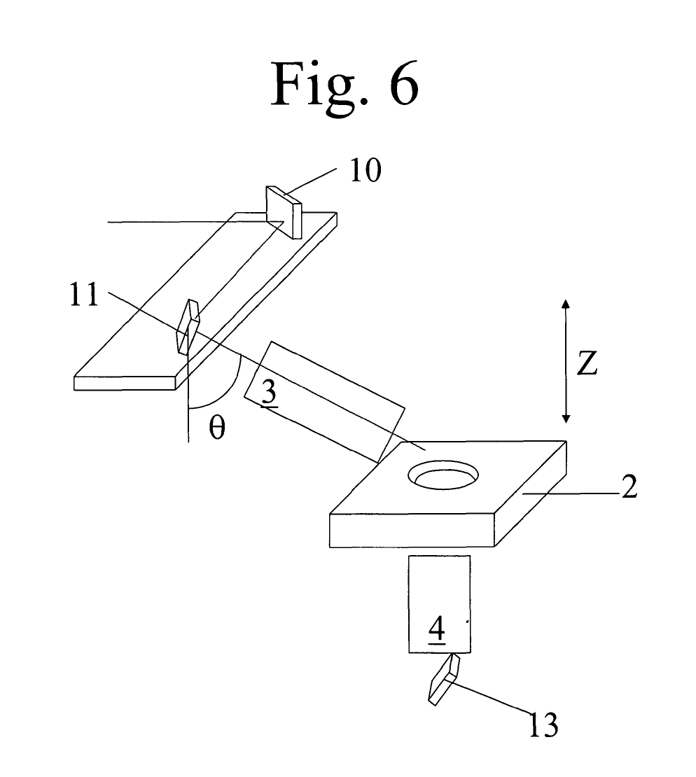

FIG. 6 illustrates a mirror system C with an adjustable incident angle (θ) for the side objective 3, in which objects 3 and 11 rotate together. Objects 3 and 4 move independently on XYZ translational stages.

The key elements of the present invention are as follows:
1. The side 3, including at least one side optics element, and bottom 4 or top illumination/collection optics schemes (objectives, lenses, or better apertures), easily switchable, possibly used simultaneously, using a system of mirrors.
2. The system of mirrors 10-13 makes it possible to easily switch between side and inverted or upright objectives, to use both objectives simultaneously (as in FIG. 4), and/or to rotate the side viewing angle (as in FIG. 6). This provides a novel device which can switch between objectives and/or rotate the side viewing angle which could be used for other applications.
3. In the XYZ sample scanning stage(s), the z position is determined through a feedback system during scanning.
4. During scanning, the feedback system monitors either i) frequency, phase, and/or amplitude of the vibration of a tuning fork/oscillator or cantilever, or ii) light deflection from mechanical bending of a cantilever, or iii) the tunneling current through the tip.
5. The Tip is attached to a fixed crystal oscillator or cantilever. The tuning fork or low vibration amplitude cantilever, or tunneling tip, assures true “non-contact” between the tip and sample, which is important for a-NSOM. The crystal oscillator or cantilever may be placed on another XYZ-stage(s), but it also can be placed just on a Z-stage.
6. Means to control remotely (not manually) the beam position with accuracy better than 100 nm. The two objectives (beam position) may be fixed with respect to each other in at least one plane or move independently in all directions.

For the purpose of this application, the terms microscope, aperture, lens, and objective are used to refer to similar devices. Microscope is also a general term, which typically is applied to a whole apparatus. When speaking of specific parts, the terms aperture/lens/objective may be used interchangeably, in increasing order of specificity.

The present invention is a three-in-one microscope with scanning capability, to use as a stand alone device or to be attached/optically-coupled to any spectrometer and/or camera, and used as a i) confocal optical microscope, ii) scanning probe microscope (SPM), or iii) an apertureless near-field scanning optical microscope (a-NSOM). It is an apparatus with optical objectives for illuminating and collecting light from the side, top, and the bottom. A crystal oscillator 3A-D or cantilever 3E, held by a fixed or adjustable stage 1 holds a very sharp tip 3A-E with its apex located in the focal spot of at least one of said optical objectives 3, 4 (top is not illustrated). Said tip acts as a nanoantenna to focus energy of light in the near-field close to the sample surface and to amplify the electric fields of incident and scattered (and/or re-irradiated) light in the near vicinity of the tip. Said sample is characterized optically, topographically, chemically, or otherwise by the tip and/or optical beam.

In this first embodiment, the beam positions, determined by the mirrors 10-13 and objectives (or lenses, or apertures), are adjusted spatially by moving the objectives in all three spatial directions—x, y, and z. The side objective (aperture or lens) 3 also translates in the direction of the optical axis to allow focusing on the surface. The side and bottom objectives can be moved either independent in all three directions or can be coupled in at least one direction. In some cases, only one objective will be used. In other cases, more than one objective will be used—at least one for light illumination, and at least one for collection. In the case where more than one objective is used, the apertures or lenses controlling both optical axes will be positioned as to cross at the focal spots of both apertures (or lenses). When the two optical axes are crossing in the focal spots of more than one objective, the tip and sample are also placed in this focal spot.

In the first embodiment for a-NSOM, said tip is maintained at a constant distance from the sample, (with its long axis approximately normal to the sample plane). In a-NSOM scanning mode, the tip position control stage(s) should be fixed while the sample is scanned in x, y, and z. The tip vibrates approximately perpendicular to the sample without contact with the sample 5 and 3C. A translational (e.g., piezo) stage or stages 2 holds the sample and moves it in x, y, and z spatial dimensions as determined by the feedback from said tip to maintain constant distance between the tip and sample, to less than 5 nm, better to be within 1-2 nm, or less than 1 nm without contact (at this scale it is technically difficult to define contact).

In FIG. 4, mirror 11 translates, rotates, or is otherwise removable to switch between side and bottom objectives. In this embodiment, the two objectives are fixed relative to one another in one plane and move independently within that plane. In FIG. 5, the side objective 3 is removable and the sample stage 2 slides vertically to switch between side and bottom objectives. FIG. 6 illustrates that the incident angle of the side objective, relative to the sample plane (or the tip axis), can be rotated. The rotation illustrated in FIG. 6 may be incorporated into the schemes illustrated in FIGS. 4 and 5. This patent is to include any combination of translational or rotational positioning of mirrors and objectives (apertures) that may be obviously envisioned by one skilled in the art as an extension of this description.

### Tip Alternatives:

In another embodiment (possibly as part of the first embodiment) the tip is mounted on a position control stage(s) for x, y, and z position control. In a-NSOM scanning mode, the tip position control stage(s) should be fixed while the sample is scanned in x, y, and z, but in some cases (tip retraction), the tip should move while the sample remains fixed in space to within ˜1 nm. Recently developed technologies make such flexibility and control possible.

In another embodiment, the tip vibrates approximately parallel to the sample plane without contact with the sample plane 3B-D. In this arrangement, tip-sample distance control is maintained by what is called shear-force feedback, and may be monitored using the frequency, amplitude, or phase of the crystal oscillator. The tip may be attached to a tuning fork, as seen in FIG. 3, item 6. The tip may also be cantilevered as in traditional non-contact SPM as shown in FIG. 3, items 3B, 3C, and 3D.

In another embodiment (beneficial in some cases of SPM mode, and possibly a-NSOM), said tip may be in contact or intermittent contact (tapping) with said sample. The tip may also be cantilevered as in traditional non-contact SPM as shown in FIG. 3, item 3E.

In another embodiment, the tip may remain at a constant distance from said sample by means of electrical, magnetic, chemical, or physical interactions with said sample.

In another embodiment, the tip may vibrate within a fluid sample.

### Optical Element Alternatives:

Apertures 3 (side) and 4 (inverted) may consist of any combination of microscope objective, lens, or aperture including but not limited to long working distance, oil/liquid immersion, and fiber optic.

### Mirror Alternatives:

Mirror 11 may be a reflective mirror only or a semi-reflective (semi-transparent) mirror. In each case, the schematic in FIG. 4 is similar. If reflective, mirror will be slidable, rotatable, or otherwise removable to allow easy switching between side and inverted microscopes. If semi-reflective, both side and inverted microscopes may be used simultaneously.

The light pathway between mirrors 11 and 13, drawn as reflected by mirror 12, is representative only and is meant to include additional mirrors as needed.

The present invention can be understood in the context of prior art devices:
a. Traditional NSOM (A. Lewis Nat. Biotech. 2003)—There is a field of near-field scanning optical microscopy (NSOM, also referred to as SNOM) that is very similar to the field of this invention. In traditional NSOM, an aperture-limited probe is used. The present invention cannot be used for the traditional NSOM. The present invention is designed for apertureless NSOM (a-NSOM). a-NSOM has an inherent advantage over traditional NSOM—higher optical throughput, or collected signal. Our device will allow users to collect a-NSOM data similar to that from traditional NSOM, but with at least 2 distinct advantages: i) faster and ii) significantly better spatial resolution.
b. Other a-NSOM devices (N. Anderson and S. Patane): Other a-NSOM devices exist, but none combine all the features of this invention, which configures an a-NSOM device to be most effective as an optical imaging device with nanoscale spatial resolution.
   i. Bottom, or Inverted, microscope—In this optical scheme, the light is focused and/or collected below the tip-sample interface. This limits its usefulness to transparent substrates and samples. This invention has an inverted microscope, but it also has a side illumination/collection microscope. Including a side-angle microscope makes this invention more diverse (possibility to work with non-transparent samples and/or samples on non-transparent substrates) than inverted microscopes and a more efficient device for plasmon-based enhancement during a-NSOM measurements. Additionally, obtaining optimum polarization relative to the tip axis is easier in side illumination than in bottom illumination.
   ii. Top, or Upright, microscope—In this optical scheme, the light is focused and/or collected above the tip-sample interface. The maximum near-field enhancement (scattered light with highest intensity/area) in any a-NSOM occurs at the tip-sample junction, which is partially or totally blocked from the upright microscope. The present invention may also include an upright microscope, but the side microscope collects the scattered light from the region where maximum near-field enhancement occurs. This invention has at least 2 distinct advantages over upright microscopes: i) faster (stronger enhancement, including additional lightning rod effect, and better collection of the enhanced signal=higher signal=faster), ii) better spatial resolution (limited by the tip shadowing in the top-illuminated scheme).
   iii. Other Side-illumination/collection microscopes: Existing side microscopes for a-NSOM scan the sample in the x and y directions and the tip in the z-direction. In such a construction, the tip moves in and out of the focal spot of the incident light. This restricts use to samples with small (<100 nm) topographic features. This invention, with side microscope a-NSOM, will scan by moving the sample in the x, y, and z directions, keeping the tip in the focus of the optical scheme, eliminating the restriction on topographic feature size. Another advantage of our device is the automated control of the side (& bottom) objective positions. Other devices have manual positioning stages, which do not provide the necessary accuracy or stability for this technique. There are 2 main advantages: i) allows a-NSOM of larger surface features and ii) more precise control of beam position resulting in higher local signal.

### Present Design:

Attach a probe, which is capable of generating electromagnetic field enhancement near the probe apex by generation of surface plasmons in response to irradiation by an at least quasi-monochromatic light source, to a tuning fork or other type of crystal oscillator (5-8). The orientation of the fork and probe may be in any geometrical relationship to the surface. Such relationships are known in the art, such as is disclosed in U.S. Pat. No. 7,047,796, the teachings of which are incorporated herein by reference. The tip oscillations can be approximately vertical or approximately horizontal. Cross the optical axes of side, inverted, and upright objectives (apertures or lenses) in such a way that their focal spots coincide or converge to a single focal spot using the translational stages supporting the objectives (apertures or lenses). Position the sample surface to the said focal spot. Position the tip within said focal spot, very near to the sample surface. Maintain a very close distance (<5 nm) between the probe and sample by adjusting the sample z-position of the sample stage(s) 2 based on the frequency, amplitude, or phase of the tuning fork (crystal oscillator). Scan the sample in the x and y directions and collect the light from the side 3 (or inverted 4, or upright (not illustrated) microscope objective and the height of the topography (z-axis position of the sample) for analysis.

### Alternatives:

Instead of adjusting the position of the objectives, keep the objectives fixed within a single optical plane and adjust the x-y-z position of the tuning fork & probe with automated positioning controls.

Instead of tuning fork or crystal, use a cantilevered probe.

Instead of frequency, amplitude, or phase of the tuning fork for feedback, use reflection of an optical beam, magnetic force, or tunneling current.

For a non-transparent substrate or sample, instead of crossing optical axes, the side aperture or lens will provide the only focal spot.

The following patents and publications are incorporated herein by reference:
1. N. Anderson, A. Bouhelier, L. Novotny, “Near-field photonics: tip-enhanced microscopy and spectroscopy on the nanoscale,” J. Opt. A: Pure Appl. Opt. 8 S27-S233 (2006).
2. A. Lewis, H. Taha, A. Strinkovski, A. Manevitch, A. Khatchatouriants, R. Dekter, E. Ammann, “Near-field optics: from subwavelength illumination to nanometric shadowing,” Nat. Biotech. 21 1378-1386 (2003). (Review article)
3. Z. Ma, J. M. Gerton, L. A. Wade, S. R. Quake. “Fluorescence Near-Field Microscopy of DNA at Sub-10 nm Resolution,” Phys. Rev. Lett. 97 260801 (2006).
4. S. Patane, P. G. Gucciardi, M. Labardi, M. Allegrini, “Apertureless near-field optical microscopy,” Rivista Del Nuovo Cimento 27 1-46 (2004).
5. U.S. Pat. No. 7,047,796 to A. Lewis, A. Komisar, H. Taha, and A. Ratner, entitled “Multiple plate tip or sample scanning reconfigurable scanned probe microscope with transparent interfacing of far-field optical microscopes” (Assignee: Nanonics, Inc.).
6. U.S. Pat. No. 6,002,471 to S. R. Quake, entitled “High resolution scanning Raman microscope” (Assignee: CalTech)
7. U.S. Pat. No. 6,953,927 to S. R. Quake, G. Lessard, L. A. Wade, and J. M. Gerton, entitled “Method and system for scanning apertureless fluorescence microscope” (Assignee: CalTECH).
8. U.S. Pat. No. 6,850,323 to M. S. Anderson, entitled “Locally enhanced Raman spectroscopy with an atomic force microscope”.
9. U.S. Pat. No. 6,643,012 to Z. X. Shen and W. Sun, entitled “Apertureless near-field scanning Raman microscopy using reflection scattering geometry” (Assignee: National Institute of Singapore).
10. U.S. Pat. No. 6,985,223 to V. P. Drachev, V. M. Shalaev, and A. K. Sarychev, entitled “Raman imaging and sensing apparatus employing nanoantennas”.
11. U.S. Pat. No. 5,641,896 to K. Karrai, entitled “Coupled oscillator scanning image,”.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What we claim is:

1. A microscope for performing apertureless near-field scanning optical microscopy on a sample comprising:
A. means for mounting a sample;
B. a scanning probe;
C. means for illuminating the sample with light along optical axes from at least two illumination angles relative to an imaginary line connecting the probe and the sample;
D. means for enhancing the electric field of light in a region of the sample with the probe;
E. means for scanning the sample in a plane perpendicular to an imaginary line connecting the probe and the sample;
F. means for moving said sample along said imaginary line to maintain a nearly constant distance between the probe and the sample; and
G. means for collecting light scattered, emitted, or transmitted from the sample.

2. A microscope according to claim 1, wherein means for illumination includes an aperture, lens, or objective.

3. A microscope according to claim 1, wherein one of two optical axes is parallel to said imaginary line connecting said probe and said sample.

4. A microscope according to claim 1, wherein one of two optical axes is non-parallel and non-perpendicular to said imaginary line connecting said probe and said sample.

5. A microscope according to claim 1, wherein means for mounting a sample includes free optical access to said sample from at least one of said optical axes.

6. A microscope according to claim 1, wherein said probe is cantilevered.

7. A microscope according to claim 1, wherein said probe is attached to a crystal oscillator

8. A microscope according to claim 1, wherein said probe is metal, coated with metal, or comprises at least one metal particle at the end of a probe.

9. The microscope according to claim 1, wherein the means for moving comprises a means for producing a relative lateral scanning motion between said probe and said sample to obtain an image related to changes in the amount of light scattered, emitted, or transmitted by different portions of a plurality of regions of said sample.

10. The microscope according to claim 1, wherein the distance between said probe and said sample is controlled using at least one of the following parameters: frequency, phase, or amplitude of said cantilever or crystal oscillator.

11. The microscope according to claim 1, wherein the distance between said probe and said sample is controlled using optical deflection from said cantilever or crystal oscillator.

12. The microscope according to claim 1, wherein the means for collecting light occurs along the same optical axes as illumination.

13. The microscope according to claim 1, wherein the means for collecting light occurs along different optical axes from illumination.

14. A microscope according to claim 1 wherein the spatial positions of said optical axes are aligned by non-manual means such that the focal spots align as to include said probe at least close to said sample.

15. The microscope according to claim 1 wherein the means for enhancing the electric field of light in a region of the sample with the probe includes maintaining a constant spatial position of the probe within the focal spot(s) of the illuminating light.

16. The microscope according to claim 1 further including a means for detecting and analyzing collected light.

17. The microscope according to claim 1 further including a means for detecting and analyzing collected light selected from the group consisting of spectrometers, spectrographs, spectral filters, charge coupled devices, avalanche photodiodes, photomultiplier tubes, digital cameras, sensors for electromagnetic radiation, and combinations thereof.

18. A method of performing apertureless near-field scanning optical microscopy, comprising: focusing light onto a small spot on a surface of a sample; placing a probe at least close to said surface at a location within said spot; scanning the sample in a plane perpendicular to an imaginary line connecting the probe and the sample while moving said sample along said imaginary line to maintain a nearly constant distance between the probe and the sample; collecting scattered, emitted, or transmitted light from the vicinity of the probe and the sample.

19. The method according to claim 18, wherein the probe enhances a near-field optical signal.

20. The method according to claim 18, wherein the laser beam is approximately parallel to said imaginary line connecting said probe and said sample.

21. The method according to claim 18, wherein said focused light is non-parallel and non-perpendicular to said imaginary line.

22. The method according to claim 18, wherein said metal tip and said focusing light originate from the same side of said sample.

23. The method according to claim 18, wherein said metal tip and said focusing light originate from different sides of said sample.

24. The method according to claim 18, wherein said metal tip and said collected light originate from the same side of said sample.

25. The method according to claim 18, wherein said metal tip and said collected light originate from different sides of said sample.

26. The method according to claim 18, wherein movement of the sample along said imaginary line is controlled by at least one of the following parameters: the frequency, amplitude, or phase of a cantilever or crystal oscillator.

27. The method according to claim 18, wherein movement of the sample along said imaginary line is controlled by an optical beam, magnetic force, or tunneling current.

28. The method according to claim 18, wherein means for detecting and analyzing collected light includes but is not limited to use of spectrometers, spectrographs, spectral filters, charge coupled devices, avalanche photodiodes, photomultiplier tubes, or other digital cameras or sensors for electromagnetic radiation.

29. A system of optical elements for optical microscopy or spectroscopy, comprising
at least one objective;
at least one mirror; and
a support means capable of rotating about at least one axis to create a non-upright and non-inverted optical axis.
